(19) United States
(12) Patent Application Publication
(10) Pub. No.: US 2024/0191116 A1
(43) Pub. Date: Jun. 13, 2024

(54) FRICTION MATERIAL

(71) Applicant: AKEBONO BRAKE INDUSTRY CO., LTD., Chuo-ku, Tokyo (JP)

(72) Inventors: Kenta KIMURA, Tokyo (JP); Motoyuki MIYAJI, Tokyo (JP); Hiroshi YAMAMOTO, Tokyo (JP); Kentaro OWA, Tokyo (JP); Yuta WATANABE, Tokyo (JP)

(73) Assignee: AKEBONO BRAKE INDUSTRY CO., LTD., Chuo-ku, Tokyo (JP)

(21) Appl. No.: 18/279,120

(22) PCT Filed: Feb. 17, 2022
(86) PCT No.: PCT/JP2022/006491

§ 371 Date: Feb. 15, 2024

(30) Foreign Application Priority Data
Mar. 29, 2021 (JP) 2021-055257

(51) Int. Cl. C09K 3/14; C09K 105/00; F16D 69/02

(52) U.S. Cl. CPC C09K 3/149; F16D 69/026; C09K 2105/00

(57) ABSTRACT

A friction material including: a friction modifier: a binder: and a fiber base material, in which an alumina fiber is contained as the fiber base material, and a content of the alumina fiber is 0.1 mass % to 1.0 mass. The alumina fiber preferably includes Al₂O₃ and SiO₂, and a chemical composition ratio of Al₂O₃ and SiO₂ is preferably Al₂O₃:SiO₂=70:30 to 80:20.

### TECHNICAL FIELD

The present invention relates to a friction material for use in automobiles, railway vehicles, industrial machines, and the like.

### BACKGROUND ART

In the related art, friction materials have been required to have various performances, one of which is, for example, a rust removal property. The rust removal property is a performance to scrape off rust generated on a surface of a disc rotor, which is a mating material, due to environmental factors such as rain, and is regarded as important from the viewpoint of preventing brake squeal or early wear of the friction material due to the generated rust.

As a friction material having a high rust removal property, for example, Patent Literature 1 discloses a friction material containing a fiber base material, a filler, and a binder as main components, in which the fiber base material is made from a non-metallic inorganic material, contains an inorganic fiber having a medium hardness of 4 to 8 in terms of Mohs hardness, and is free of an inorganic fiber having a length of 5 μm or more, a diameter of 3 μm or less, and an aspect ratio (length/diameter) of more than 3, the filler contains a rubber, and a volume ratio of an added amount of the inorganic fiber having a medium hardness to an added amount of the rubber is 2:1 to 10:1.

On the other hand, in recent years, regenerative cooperative braking, which is peculiar to hybrid vehicles and electric vehicles, has become widespread, and regenerative braking is responsible for part of the braking. Therefore, a braking percentage and a braking load due to friction are reduced compared to a conventional hydraulic braking system. As a result, with the friction material in the related art disclosed in Patent Literature 1, it is difficult to sufficiently remove the rust generated on the surface of the disc rotor, which is a mating material.

Therefore, as a friction material having a further improved rust removal property, for example, Patent Literature 2 discloses a friction material composition containing a fibrous matrix, a binder, and a filler, in which the fibrous matrix contains at least two biosoluble ceramic fibers having different fiber lengths.

### CITATION LIST

### Patent Literature

Patent Literature 1: JP2007-186591A

Patent Literature 2: WO 2007/080975

### SUMMARY OF INVENTION

### Technical Problem

However, according to studies of the present inventors, the friction material disclosed in Patent Literature 2 requires a large amount of ceramic fibers, and there is a problem that abradability of the ceramic fibers increases aggressiveness against a mating material.

The present invention has been made in view of the above circumstances, and an object thereof is to provide a friction material having low aggressiveness against a mating material and an excellent rust removal property.

### Solution to Problem

As a result of intensive studies, the present inventors have found that when a friction material contains a specific amount of alumina fiber as a fiber base material, the above problem can be solved. Thus, the present invention has been completed.

That is, the present invention relates to the following <1>to <4>.
<1>A friction material including:
a friction modifier:
a binder; and
a fiber base material, in which
an alumina fiber is contained as the fiber base material, and
a content of the alumina fiber is 0.1 mass % to 1.0 mass %.
<2>The friction material according to <1>, in which
the alumina fiber includes Al₂O₃ and SiO₂, and
a chemical composition ratio of Al₂O₃ and SiO₂ is Al₂O₃:SiO₂=70:30 to 80:20.
<3>The friction material according to <1>or <2>, in which
the alumina fiber has an average fiber length of 50 μm to 150 μm.
<4>The friction material according to any one of <1>to <3>, which is free of a copper component.

### Advantageous Effects of Invention

The friction material according to the present invention has low aggressiveness against a mating material and an excellent rust removal property.

### DESCRIPTION OF EMBODIMENTS

Hereinafter, the present invention will be described in detail, but these show examples of desirable embodiments, and the present invention is not specified in these contents.

A friction material according to the present invention contains a friction modifier, a binder, and a fiber base material.

Hereinafter, each component will be described in detail.

### <Friction Modifier>

The friction modifier is used to impart desired friction properties such as wear resistance, heat resistance, and fade resistance to the friction material.

Examples of the friction modifier include an inorganic filler, an organic filler, an abrasive, a lubricant, and a metal powder.

Examples of the inorganic filler include inorganic materials, for example, titanates such as potassium titanate, lithium titanate, lithium potassium titanate, sodium titanate, calcium titanate, magnesium titanate, and potassium magnesium titanate, and barium sulfate, calcium carbonate, calcium hydroxide, vermiculite, and mica. These may be used alone or in combination of two or more thereof.

The inorganic filler is preferably used in an amount of 30 mass % to 80 mass %, and more preferably 40 mass % to 70 mass %, in the entire friction material.

Examples of the organic filler include various rubber powders (a raw rubber powder, a tire powder, etc.), rubber dust, resin dust, cashew dust, tire tread, and melamine dust. These may be used alone or in combination of two or more thereof.

The organic filler is preferably used in an amount of 1 mass % to 15 mass %, and more preferably 1 mass % to 10 mass %, in the entire friction material.

Examples of the abrasive include zirconium oxide, alumina, silica, magnesium oxide, zirconia, zirconium silicate, chromium oxide, triiron tetroxide (Fe304), and chromite. These may be used alone or in combination of two or more thereof.

The abrasive is preferably used in an amount of 1 mass % to 20 mass %, and more preferably 3 mass % to 15 mass %, in the entire friction material.

Examples of the lubricant include graphite, coke, antimony trisulfide, molybdenum disulfide, tin sulfide, and polytetrafluoroethylene (PTFE). These may be used alone or in combination of two or more thereof.

The lubricant is preferably used in an amount of 1 mass % to 20 mass %, and more preferably 3 mass % to 15 mass %, in the entire friction material.

Examples of metal powder include powders of aluminum, tin, and zinc. These may be used alone or in combination of two or more thereof.

The metal powder is preferably used in an amount of 1 mass % to 10 mass %, and more preferably 1 mass % to 5 mass %, in the entire friction material.

From the viewpoint of sufficiently imparting the desired friction properties to the friction material, the friction modifier is preferably used in an amount of 60 mass % to 90 mass %, and more preferably 70 mass % to 90 mass %, in the entire friction material.

### <Binder>

As the binder, various commonly used binders can be used. Specific examples thereof include thermosetting resins such as a phenol resin, various elastomer-modified phenol resins, a melamine resin, an epoxy resin, and a polyimide resin.

Examples of the elastomer-modified phenol resins include an acrylic rubber-modified phenol resin, a silicone rubber-modified phenol resin, and a nitrile rubber (NBR)-modified phenol resin. These may be used alone or in combination of two or more thereof.

From the viewpoint of moldability of the friction material, the binder is preferably used in an amount of 1 mass % to 20 mass %, and more preferably 3 mass % to 15 mass %, in the entire friction material.

### <Fiber Base Material>

The friction material according to the present invention contains an alumina fiber as the fiber base material. A content of the alumina fiber in the friction material according to the present invention is 0.1 mass % to 1.0 mass %. When the friction material according to the present invention contains the alumina fiber in an amount of 0.1 mass % to 1.0 mass %, it is possible to well remove rust generated on a surface of a disc rotor, which is a mating material.

By controlling a firing temperature in an alumina fiber production process, the abradability of the friction material according to the present invention can be reduced, and by selecting an appropriate blending amount of the alumina fiber, the aggressiveness against a mating material of the friction material according to the present invention can be reduced. Therefore, the friction material according to the present invention can be made to have low aggressiveness against a mating material and an excellent rust removal property.

The content of the alumina fiber in the entire friction material is preferably 0.1 mass % to 0.8 mass %, and more preferably 0.2 mass % to 0.5 mass %.

The alumina fiber is an artificial mineral fiber containing alumina (Al₂O₃) and silica (SiO₂) as main components. A chemical composition ratio of Al₂O₃ and SiO₂ in the alumina fiber is preferably Al₂O₃:SiO₂=70 to 80:30 to 20, and more preferably Al₂O₃:SiO₂=70:30.

In addition, an average fiber length of alumina fiber is preferably 50 μm to 150 μm, and an average fiber diameter of the alumina fiber is preferably 1 μm to 10 μm. In the present invention, the average fiber length and the average fiber diameter of the alumina fiber can be measured by observation with a microscope or the like.

The alumina fiber can be produced by a known method. For example, a so-called precursor fiber method is used in which an organic polymer is added to a solution of aluminum salts or the like to increase the viscosity, which is then mechanically fiberized and fired.

Examples of the fiber base material include an organic fiber and an inorganic fiber in addition to those described above. These fiber base materials may be used alone or in combination of two or more thereof.

Examples of the organic fiber include an aromatic polyamide (aramid) fiber and a flame-resistant acrylic fiber.

Examples of the inorganic fiber include a biosoluble inorganic fiber, a ceramic fiber, a glass fiber, a carbon fiber, and rock wool. Examples of the biosoluble inorganic fiber include biosoluble ceramic fibers such as a SiO₂—CaO—MgO-based fiber, a SiO₂—CaO—MgO—Al₂O₃-based fiber, and a SiO₂—MgO—SrO-based fiber, and biosoluble rock wool.

From the viewpoint of ensuring strength of the friction material, the fiber base material is preferably used in an amount of 3 mass % to 30 mass %, and more preferably 5 mass % to 20 mass %, in the entire friction material.

From the viewpoint of reducing an environmental load, the friction material according to the present invention is preferably free of a copper component.

### <Method for Producing Friction Material>

The friction material according to the present invention can be produced by a known production process, and, for example, the friction material can be produced by blending the above components, and subjecting the blended material to steps such as preforming, hot molding, heating, and grinding according to a usual production method.

A method for producing a brake pad provided with the friction material generally includes the following steps:
(a) a step of forming a pressure plate into a predetermined shape by using a sheet metal press:
(b) a step of applying a degreasing treatment, a chemical conversion treatment, and a primer treatment to the pressure plate and coating the pressure plate with an adhesive:
(c) a step of blending raw materials such as a friction modifier, a binder, and a fiber base material, performing sufficient homogenization by mixing, and performing molding at a predetermined pressure at room temperature to prepare a preformed body:
(d) a hot molding step of integrally fixing the preformed body and the pressure plate coated with the adhesive by applying a predetermined temperature and pressure (molding temperature: 130° C. to 180° C., molding pressure: 30 MPa to 80 MPa, molding time: 2 minutes to 10 minutes); and
(e) a step of performing after-cure (150° C. to 300° C., 1 hour to 5 hours) and finally performing finishing treatments such as grinding, scorching, and painting.

### EXAMPLES

The present invention will be specifically described by way of the following Examples, but the present invention is not limited thereto.

### Examples 1 to 8 and Comparative Examples 1 to 4

Blending materials shown in Table 2 were collectively charged into a mixer and mixed at room temperature for 4 minutes to obtain a mixture.

As the alumina fiber, the following alumina fibers were used.

Alumina fiber A: Al₂O₃:SiO₂=70:30 (chemical composition ratio), average fiber length: 50 μm

Alumina fiber B: Al₂O₃:SiO₂=70:30 (chemical composition ratio), average fiber length: 100 μm

Alumina fiber C: Al₂O₃:SiO₂=70:30 (chemical composition ratio), average fiber length: 150 μm

Alumina fiber D: Al₂O₃:SiO₂=80:20 (chemical composition ratio), average fiber length: 100 μm

The obtained mixture was subjected to the following steps of (i) preforming, (ii) hot molding, and (iii) heat treatment and scorching to prepare a friction material.

### (i) Preforming

The mixture was charged into a mold of a preforming press and molded at room temperature at 20 MPa for 10 seconds to prepare a preformed body.

### (ii) Hot Molding

The preformed body was charged into a hot molding mold, metal plates (pressure plates) coated with an adhesive in advance were stacked, and hot press molding was performed at 150° C. and 40 MPa for 5 minutes.

(iii) Heat Treatment and Scorching

The hot-press molded body was subjected to a heat treatment at 250° C. for 3 hours and then the surface thereof was grinded.

Next, the surface of the hot-press molded body was scorched and finished by a painting to obtain a friction material.

The friction materials obtained in Examples 1 to 8 and Comparative Examples 1 to 4 were evaluated for the rust removal property and the aggressiveness against to a mating material by the following methods. The results are shown in Table 2.

### <Rust Removal Property>

Using each of the friction materials obtained above, a new rotor, and a rusted disc rotor, a rust removal test was performed under the test conditions shown in Table 1 using a 1/7 scale tester.

During the rust removal test, an amount of disc rotor wear was measured at the following number of times of braking. Before test (0 times), 10 times, 30 times, 50 times, 100 times, 150 times, 200 times

A rusted disc rotor was obtained by the procedure described below.
(a) A 5 mass % aqueous salt solution was sprayed onto a disc rotor.
(b) The disc rotor in the above (a) was left for 3 hours and 15 minutes in a constant temperature and humidity chamber maintained at a temperature of 50° C.±1° C. and a humidity of 95±1%, and was then dried for 2 hours and 30 minutes under the conditions of 70° C.±1° C. and 15±1% humidity in accordance with JIS D4419.
(c) The above operation (b) was repeated until a rust thickness reached 70 μm.

TABLE 1

| | | Test condition | | | |
|---|---|---|---|---|---|
| | | | | | Number of |
| | | | | Rotor | times of |
| | | Speed | Deceleration | temperature | braking |
| No. | Test item | (km/h) | (m/s²) | (° C.) | (times) |
| 1 | New disc rotor | 65→0 | 3.43 | 120 | 200 |
| 2 | Rusted disc | 65→0 | 3.43 | 120 | 200 |
| | rotor | | | | |

Based on the following equation, a rust removal rate after braking 100 times was calculated.

$$Rust removal rate [ \% ] = \qquad [ Math . 1 ]$$

$$\frac{\begin{matrix}initial thickness of rusted disc rotor - \\ thickness of rusted disc rotor after braking 100 times\end{matrix}}{\begin{matrix}initial thickness of rusted disc rotor - \\ thickness of new disc rotor\end{matrix}} \times 100$$

The calculated rust removal rate was evaluated based on the following criteria.

⊚: 100% or more
∘: 90% or more and less than 100%
Δ: 80% or more and less than 90%
×: less than 80%

### <Aggressiveness Against Mating Material>

Each of the friction materials obtained above was processed into a test piece, the test piece was pressed against a disc rotor with a surface pressure of 0.08 MPa, and tested at a speed of 60 km/h. After 40 hours, the amount of disc rotor wear was measured.

The measured amount of disc rotor wear was evaluated based on the following criteria.

⊚: less than 10 μm
∘: 10 μm or more and less than 15 μm
Δ: 15 μm or more and less than 20 μm
×: 20 μm or more

TABLE 2
(mass %)

| | | | Example | | | | | |
|---|---|---|---|---|---|---|---|---|
| | | | 1 | 2 | 3 | 4 | 5 | 6 |
| Binder | | Phenol resin | 8 | 8 | 8 | 8 | 8 | 8 |
| Friction | Organic | Cashew dust | 4 | 4 | 4 | 4 | 4 | 4 |
| modifier | filler | Tire tread | 1 | 1 | 1 | 1 | 1 | 1 |
| | Inorganic | Calcium | 3 | 3 | 3 | 3 | 3 | 3 |
| | filler | hydroxide | | | | | | |
| | | Mica | 5 | 5 | 5 | 5 | 5 | 5 |
| | | Calcium titanate | 20 | 20 | 20 | 20 | 20 | 20 |
| | | Barium sulfate | 31.7 | 31.7 | 31.7 | 31.7 | 31.9 | 31.8 |
| | Abrasive | Zirconium silicate | 6 | 6 | 6 | 6 | 6 | 6 |
| | | Triiron tetroxide | 5 | 5 | 5 | 5 | 5 | 5 |
| | Solid | Graphite | 6 | 6 | 6 | 6 | 6 | 6 |
| | lubricant | Tin sulfide | 3 | 3 | 3 | 3 | 3 | 3 |
| | Metal powder | Zinc powder | 2 | 2 | 2 | 2 | 2 | 2 |

| Fiber base material | Alumina fiber A | 0.3 | — | — | — | — | — |
|---|---|---|---|---|---|---|---|
| | Alumina fiber B | — | 0.3 | — | — | 0.1 | 0.2 |
| | Alumina fiber C | — | — | 0.3 | — | — | — |
| | Alumina fiber D | — | — | — | 0.3 | — | — |
| | Aramid fiber | 3 | 3 | 3 | 3 | 3 | 3 |
| | Biosoluble | 2 | 2 | 2 | 2 | 2 | 2 |
| | inorganic fiber | | | | | | |

| Total | | 100 | 100 | 100 | 100 | 100 | 100 |
|---|---|---|---|---|---|---|---|
| Test | Rust removal rate [%] after braking | 103 | 102 | 100 | 102 | 96 | 100 |
| result | 100 times | | | | | | |
| | Evaluation | ⊚ | ⊚ | ⊚ | ⊚ | ◯ | ⊚ |
| | Amount of disc rotor wear [μm] | 9 | 8 | 8 | 9 | 5 | 7 |
| | Evaluation | ⊚ | ⊚ | ⊚ | ⊚ | ⊚ | ⊚ |

(mass %)

| | | | Example | | Comparative Example | | | |
|---|---|---|---|---|---|---|---|---|
| | | | 7 | 8 | 1 | 2 | 3 | 4 |
| Binder | | Phenol resin | 8 | 8 | 8 | 8 | 8 | 8 |
| Friction | Organic | Cashew dust | 4 | 4 | 4 | 4 | 4 | 4 |
| modifier | filler | Tire tread | 1 | 1 | 1 | 1 | 1 | 1 |
| | Inorganic | Calcium | 3 | 3 | 3 | 3 | 3 | 3 |
| | filler | hydroxide | | | | | | |
| | | Mica | 5 | 5 | 5 | 5 | 5 | 5 |
| | | Calcium titanate | 20 | 20 | 20 | 20 | 20 | 20 |
| | | Barium sulfate | 31.5 | 31.0 | 32.0 | 28.0 | 26.0 | 24.0 |
| | Abrasive | Zirconium silicate | 6 | 6 | 6 | 6 | 6 | 6 |
| | | Triiron tetroxide | 5 | 5 | 5 | 5 | 5 | 5 |
| | Solid | Graphite | 6 | 6 | 6 | 6 | 6 | 6 |
| | lubricant | Tin sulfide | 3 | 3 | 3 | 3 | 3 | 3 |
| | Metal powder | Zinc powder | 2 | 2 | 2 | 2 | 2 | 2 |

| Fiber base material | Alumina fiber A | — | — | — | — | — | — |
|---|---|---|---|---|---|---|---|
| | Alumina fiber B | 0.5 | 1.0 | — | — | — | 2.0 |
| | Alumina fiber C | — | — | — | — | — | — |
| | Alumina fiber D | — | — | — | — | — | — |
| | Aramid fiber | 3 | 3 | 3 | 3 | 3 | 3 |
| | Biosoluble | 2 | 2 | 2 | 6 | 8 | 8 |
| | inorganic fiber | | | | | | |

| Total | | 100 | 100 | 100 | 100 | 100 | 100 |
|---|---|---|---|---|---|---|---|
| Test | Rust removal rate [%] after braking | 104 | 107 | 89 | 98 | 108 | 113 |
| result | 100 times | | | | | | |
| | Evaluation | ⊚ | ⊚ | Δ | ◯ | ⊚ | ⊚ |
| | Amount of disc rotor wear [μm] | 9 | 14 | 2 | 16 | 21 | 30 |
| | Evaluation | ⊚ | ◯ | ⊚ | Δ | X | X |

From the results in Table 2, it is found that the friction materials according to Examples 1 to 8 have low aggressiveness a mating material and an excellent rust removal property.

Although the present invention has been described in detail with reference to a specific embodiment, it will be apparent to those skilled in the art that various changes and modifications can be made without departing from the spirit and the scope of the present invention. The present application is based on a Japanese Patent Application (Japanese Patent Application No. 2021-055257) filed on Mar. 29, 2021, and the content thereof is incorporated herein by reference.

What is claimed is:

1. A friction material comprising:
a friction modifier,
a binder, and
a fiber base material, wherein
an alumina fiber is contained as the fiber base material, and
a content of the alumina fiber is 0.1 mass % to 1.0 mass %.

2. The friction material according to claim 1, wherein
the alumina fiber comprises Al₂O₃ and SiO₂, and
a chemical composition ratio of Al₂O₃ and SiO₂ is Al₂O₃:SiO₂=70:30 to 80:20.

3. The friction material according to claim 1 or 2, wherein
the alumina fiber has an average fiber length of 50 μm to 150 μm.

4. The friction material according to any one of claims 1 to 3, which is free of a copper component.
